(19) United States
(12) Patent Application Publication
(10) Pub. No.: US 2026/0164396 A1
(43) Pub. Date: Jun. 11, 2026

(54) SYSTEM AND METHOD FOR DETECTING AND LOCATING OFFLINE TRACKING DEVICES

(71) Applicant: Nano and Advanced Materials Institute Limited, Hong Kong (HK)

(72) Inventors: Ka Chun LAU, Hong Kong (HK); Yam CHONG, Hong Kong (HK); Cheuk Yin LEE, Hong Kong (HK); Shengbo LU, Hong Kong (HK); Chenmin LIU, Hong Kong (HK)

(21) Appl. No.: 19/280,161

(22) Filed: Jul. 25, 2025

Related U.S. Application Data
(60) Provisional application No. 63/728,174, filed on Dec. 5, 2024.

(51) Int. Cl. H04W 64/00

(52) U.S. Cl. CPC H04W 64/00

(57) ABSTRACT

A method for estimating a location of a tracking device operating in a beacon mode within an environment is provided. The method includes steps as follows: receiving, by one or more standard-mode tracking devices, wireless signals transmitted from a beacon-mode tracking device; estimating, by the one or more standard-mode tracking devices, distance information regarding the beacon-mode tracking device based on characteristics of the received signals; and computing a location of the beacon-mode tracking device based on the estimated distance information.

### CROSS-REFERENCE TO RELEVANT APPLICATIONS

The present application claims priority from a U.S. provisional patent application Ser. No. 63/728,174 filed Dec. 5, 2024, and the disclosure of which is incorporated by reference in its entirety.

### TECHNICAL FIELD

The present invention relates to wireless asset tracking technologies; more specifically, it is directed to a tracking device operable in both online and offline conditions, and to a system and method for locating devices when network connectivity is unavailable or power supply is insufficient for wireless transmission.

### BACKGROUND

Asset tracking devices, commonly referred to as trackers, are widely utilized across industries to monitor the location and status of movable assets. These trackers typically rely on wireless communication technologies such as Wi-Fi, LoRa, NB-IoT, LTE, or 5G to transmit real-time location data to centralized cloud-based management systems. However, such systems are vulnerable to disruptions arising from weak or unstable network signals, hardware malfunctions within the wireless communication modules, or insufficient battery power. When any of these conditions occur, the tracker may enter an offline state and cease transmitting data, thereby rendering the asset untraceable on the monitoring platform.

This problem is particularly evident in environments involving the management of large quantities of mobile units, such as airport baggage trolleys. While smaller airports may manage a few hundred trolleys, international airports often maintain fleets exceeding 10,000 units. The complexity of managing such fleets introduces various logistical challenges, including uneven distribution, operational blind spots, and the risk of asset loss. Although tracking devices can significantly enhance the operational visibility of trolley fleets, the effectiveness of such systems is compromised when individual trackers go offline due to network or power limitations. In large-scale deployments, even a small fraction of offline trackers can result in significant administrative burdens and increased risk of asset misplacement.

Therefore, there remains a need for a tracking solution that can sustain location awareness even under offline conditions, and that enables efficient recovery and repositioning of offline trackers.

### SUMMARY OF INVENTION

It is an objective of the present invention to provide a system and a method to recover offline tracking devices, thereby addressing the aforementioned shortcomings and unmet needs in the state of the art.

In the present invention, one objective is to maintain up-to-date position information even when the tracking device experiences degraded network connectivity or when the battery voltage falls below the operational threshold required for Wi-Fi or LTE circuits. By employing a peer-to-peer positioning approach, the system ensures continuous tracking by leveraging nearby devices, benefiting from the flexibility and self-healing capabilities of a mesh network, under this situation the asset-tracking device remains in sleep mode to conserve energy. At meantime, it switches to Bluetooth beacon mode, broadcasting its unique identity to nearby asset trackers, the positioning task is seamlessly handed over to neighboring devices. The present invention provides a solution which enables operators to locate the tracker and replace its internal backup battery or fix the wireless communication module when necessary. For trackers without a backup battery, normal operation automatically resumes once solar charging restores the main battery to a sufficient level.

Another objective of the present invention is to enhance the accuracy and reliability of location determination by integrating data from multiple wireless positioning methods. The present invention provides a solution combining Received Signal Strength Indicator (RSSI) measurements, which offer low complexity and minimal resource consumption, with Channel State Information (CSI) and time-of-flight measurements, which provide higher precision. In the CSI-based approach, one device acts as an initiator while another serves as a reflector, enabling accurate distance estimation through round-trip packet transit time analysis. This hybrid positioning strategy is designed to mitigate the limitations inherent in individual techniques, such as the environmental sensitivity of RSSI, achieving robust location awareness in challenging environments, such as underground facilities and multi-level parking garages, thereby reducing the risk of asset loss.

In accordance with a first aspect of the present invention, a tracking device for recovering asset location in offline conditions is provided. The tracking device includes a movable body equipped with a battery module, a wireless communication module, a power management module, a positioning module, and a detection module. The wireless communication module is positioned at the movable body and is configured to perform wireless communication with external devices or systems. The power management module is positioned at the movable body and is configured to monitor a voltage level of the battery module and a network availability status of the wireless communication module, and to selectively activate one of a standard mode or a beacon mode based on the voltage level and the network availability. The positioning module is positioned at the movable body and is configured to: (1) in the standard mode, perform at least one wireless-based positioning process to determine a location of the tracking device; and (2) in the beacon mode, transmit a wireless signal containing an identifier at predefined time intervals. The detection module is positioned at the movable body and is configured to detect wireless signals originating from additional tracking devices operating in the beacon mode when the tracking device is operating in the standard mode.

In accordance with a second aspect of the present invention, a tracking system for locating offline tracking devices in an environment is provided. The tracking system includes more than one tracking device as afore-described and at least one transceiver unit. The transceiver unit is positioned at a fixed counter and is configured to periodically transmit wireless identification signals detectable by the tracking devices when operating in the standard mode. Each of the tracking devices is configured to receive the wireless identification signals from the transceiver unit and to use signal strength or timing characteristics of the received wireless identification signals to assist in determining the respective location of the tracking devices.

In accordance with a third aspect of the present invention, a method for estimating a location of a tracking device operating in a beacon mode within an environment is provided. The method includes steps as follows: receiving, by one or more standard-mode tracking devices, wireless signals transmitted from a beacon-mode tracking device; estimating, by the one or more standard-mode tracking devices, distance information regarding the beacon-mode tracking device based on characteristics of the received signals; and computing a location of the beacon-mode tracking device based on the estimated distance information.

### BRIEF DESCRIPTION OF DRAWINGS

Embodiments of the invention are described in more details hereinafter with reference to the drawings, in which:

FIG. 1 is a block diagram illustrating a structural configuration of a tracking device according to some embodiments of the present invention;

FIG. 2 shows a flow diagram illustrating the decision-making process for switching a tracking device between sleep mode and active mode according to some embodiments of the present invention;

FIG. 3 shows the internal workflow of a tracking device operating in standard mode;

FIG. 4 shows the operational process of a beacon-mode tracking device when it participates in active two-way ranging;

FIG. 5 illustrates an example usage scenario of a tracking system for locating assets in an environment using indoor positioning according to some embodiments of the present invention;

FIG. 6 illustrates an interactive map interface in which a tracking device disappears from view when a device is in offline status according to some embodiments of the present invention;

FIG. 7 illustrates the signal perception range of a tracking device operating in the standard mode and detecting beacon signals from a nearby offline device according to some embodiments of the present invention;

FIG. 8 illustrates an example usage scenario of a tracking system for locating assets in an environment using indoor positioning according to some embodiments of the present invention; and

FIG. 9 illustrates an interactive map interface in which a tracking device disappears from view after when a device is in offline status according to some embodiments of the present invention.

### DETAILED DESCRIPTION OF THE INVENTION

In the following description, systems and methods for locating offline tracking devices when network connectivity is unavailable or power supply is insufficient for wireless transmission and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention provides a tracking device configured to recover or maintain asset location awareness under both online and offline conditions. The device adopts a modular structure comprising a movable body and multiple function-specific modules for communication, positioning, power management, and operational state control. When the tracking device operates under healthy conditions, such as having sufficient battery voltage and available network connectivity, it functions in a standard mode for active positioning and data transmission. When these conditions are not met, the device switches to a beacon mode and can be passively detected by other tracking devices operating in the standard mode, which assist in estimating its location. The present invention further provides a system and method for operating such tracking devices and enabling cooperation among multiple devices to support location recovery in offline scenarios.

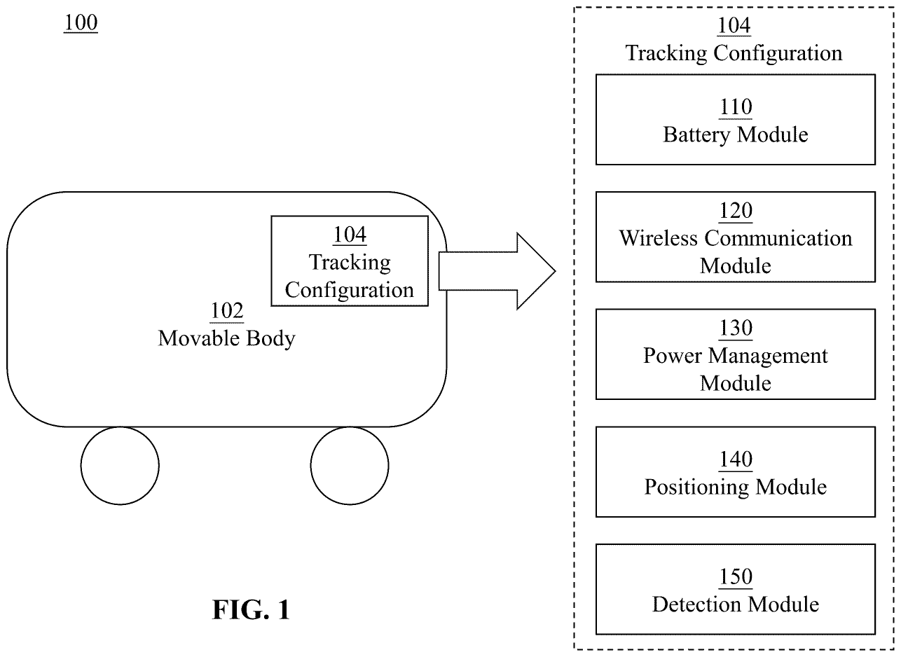

The configuration of a single tracking device is first described, followed by an explanation of how multiple tracking devices operate cooperatively within a system. FIG. 1 is a block diagram illustrating a structural configuration of a tracking device 100 according to some embodiments of the present invention. The tracking device 100 includes a movable body 102 and a tracking configuration 104 attached to the movable body 102.

The movable body 102 physically supports all hardware components of the device. The movable body 102 may be an object intended for user operation within a given environment, such as airport trolley, shopping cart, warehouse forklift, or cargo container. For example, the movable body 102 may be implemented as an airport trolley that is pushed by users during normal use. Since users may move the trolley throughout the airport in an unpredictable manner and leave it at any arbitrary location, its position cannot be reliably anticipated. Other examples of implementations of the movable body 102 include, but not limited to, manually driven and autonomous vehicles, robots and drones.

The tracking configuration 104 is mounted on the movable body 102 and is configured to assist in tracking and determining the location of the movable body 102. The tracking configuration 104 includes a battery module 110, a wireless communication module 120, a power management module 130, a positioning module 140, and a detection module 150.

The battery module 110 is positioned at the movable body 102 and is configured to supply electrical power to all other functional modules of the tracking device 100. In some embodiments, the battery module 110 may be implemented as a rechargeable battery, a primary battery cell, a solar energy harvesting component, or any combination thereof. The voltage level of the battery module 110 may be continuously monitored to assess the operational condition of the tracking device 100.

The wireless communication module 120 is positioned at the movable body 102 and configured to perform wireless communication with external devices or systems (e.g., other tracking devices). The wireless communication module 120 supports at least Wi-Fi, Bluetooth, cellular networks (e.g., LTE), and GNSS (Global Navigation Satellite System) connectivity. In some embodiments, the wireless communication module 120 can be configured to transmit location data through either Wi-Fi or cellular networks, depending on availability and signal strength. The selection of network type may be dynamically managed based on energy efficiency or signal reliability.

The power management module 130 is positioned at the movable body 102 and is configured to monitor the voltage level of the battery module 110 and the network availability status of the wireless communication module 120. The power management module 130 is responsible for selectively activating either a standard mode or a beacon mode based on predefined operational thresholds. Specifically, if the battery voltage provided by the battery module 110 is above a first threshold required for cellular communication and a second threshold required for Wi-Fi transmission, and if network connectivity is available, the standard mode is activated. Conversely, if the battery voltage falls below either the first or the second threshold but remains above a third threshold sufficient for Bluetooth beacon transmission, the beacon mode is activated instead. Additionally, even when the battery voltage provided by the battery module 110 is above either the first or the second threshold, if the network availability status of the wireless communication module 120 indicates that network communication is not available, the beacon mode is also activated, thereby enabling Bluetooth beacon transmission as an alternative communication mechanism. In some embodiments, when the beacon mode is activated, the power management module 130 may be further configured to periodically wake from a sleep mode at predefined intervals, perform a battery voltage check and a network connectivity check, and determine the operational state to be activated based on the check results.

The positioning module 140 is positioned at the movable body 102 and configured to provide location-related functionality in both standard and beacon modes. The positioning module 140 comprises at least a Bluetooth-based positioning engine and a GNSS-based positioning engine. In the standard mode, the positioning module 140 is configured to perform at least one wireless-based positioning process. The wireless-based positioning process may include GNSS signal acquisition or Bluetooth signal acquisition from fixed transceivers or other nearby devices. In the beacon mode, the positioning module 140 is configured to transmit wireless signals containing an identifier at predefined time intervals, for example, using Bluetooth Low Energy (BLE) advertising. Moreover, the positioning module 140 may support two-way ranging by measuring the round-trip time (RTT) of Bluetooth signals exchanged with another tracking device, thereby enabling accurate distance calculations under controlled signal exchange conditions.

The detection module 150 is positioned at the movable body 102 and is configured to detect wireless signals originating from other tracking devices operating in the beacon mode (i.e., particularly when the tracking device 100 is operating in the standard mode). Upon receiving such signals, the detection module 150 may estimate the position of the beacon-mode tracking device by analyzing one or more signal characteristics, including Received Signal Strength Indicator (RSSI) values for low-complexity distance approximation, Channel State Information (CSI) for advanced signal analysis, round-trip time (RTT) measurements as coordinated by the positioning module 140, or combinations thereof.

Regarding the RTT measurement, in some embodiments, the positioning module 140 of the tracking device 100 utilizes the logarithmic distance path-loss model to convert RSSI values into estimated distances between target devices. The computation model applies the formula: d=10\hat{ }((RSSI−RSSI₁ₘ)/(10*n)), and it can be expressed as:

$$RSSI = {RSSI}_{1 m} + 10 n log ( \frac{d}{{d}_{0}} )$$

where d represents the estimated distance, RSSI₁ₘ is the RSSI value measured at 1 meter from the transmitter, and n is a path-loss exponent determined by the signal attenuation characteristics of the environment. The value of n may vary depending on factors such as indoor obstacles or reflective surfaces, and is used to compensate for signal degradation during transmission. This RSSI-based calculation may be used alone or in combination with other metrics such as RTT and CSI, as described earlier, and may be executed locally by the positioning module 140 or externally by a remote computing module.

Based on the above configuration, the estimated position of a neighboring beacon-mode device may be utilized for visual representation in a cloud-based system, for issuing local alerts, or for triggering asset recovery procedures. In practical implementations, one representative use case involves sleep cycle control and autonomous mode switching.

Specifically, the tracking device 100 may be configured to operate in a low-power mode by alternating between sleep and active states. During periodic wake-up events initiated by the power management module 130, the tracking device 100 performs checks on both battery voltage and network connectivity. If both conditions meet predefined operational thresholds, the tracking device 100 enters the standard mode, activating the detection module 150, positioning module 140, and the wireless communication module 120 to execute their respective functions. If either condition fails, the power management module 130 transitions the tracking device 100 into beacon mode to conserve energy by disabling higher-power subsystems and enabling only Bluetooth advertising functionality. In some embodiments, the beacon mode may remain active as long as the battery voltage remains above the minimum threshold required for Bluetooth transmission (e.g., approximately 1.8 V), even when the voltage is insufficient to support LTE (typically >3.3 V) or Wi-Fi (typically >2.8 V). This configuration significantly extends the operational duration of tracking devices under degraded conditions, enabling continued location awareness and eventual recovery of the asset.

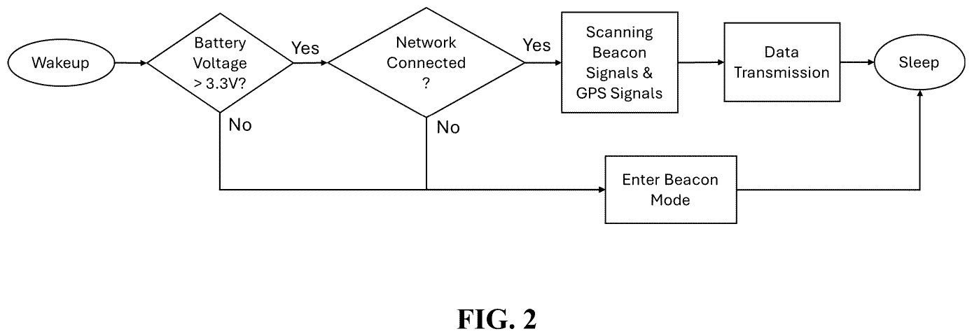

More specifically, FIG. 2 shows a flow diagram illustrating the decision-making process for switching a tracking device between sleep mode and active mode according to some embodiments of the present invention. The tracking device 100 periodically transitions into an active state at a configurable interval, such as every five minutes. This state transition is coordinated by the power management module 130, which wakes the tracking device 100 and components thereof from sleep mode and performs a series of system checks.

The first decision point checks whether the battery voltage, as measured from the battery module 110, exceeds a predefined threshold, such as 3.3V. If the result is “Yes,” the process proceeds to the next decision point, where the network connectivity status, monitored by the wireless communication module 120, is evaluated. If the network connectivity status is also connected (i.e., a “Yes” condition), the tracking device 100 enters standard mode, wherein the detection module 150 performs scanning for nearby BLE signals, and the positioning module 140 acquires positioning data, including GPS signals if available. The wireless communication module 120 then transmits the collected location data to a remote cloud server. After completing this sequence, the device returns to sleep mode.

If either the battery voltage is below the threshold or network connectivity is unavailable (i.e., a “No” condition at either decision point), the power management module 130 activates beacon mode. In the beacon mode, the positioning module 140 reconfigures the wireless communication module 120 to operate as a BLE advertiser, broadcasting beacon packets (e.g., in iBeacon format) at fixed intervals, such as once every second. After beacon transmission, the tracking device 100 and components thereof also return to a low-power sleep state, awaiting the next wake-up cycle.

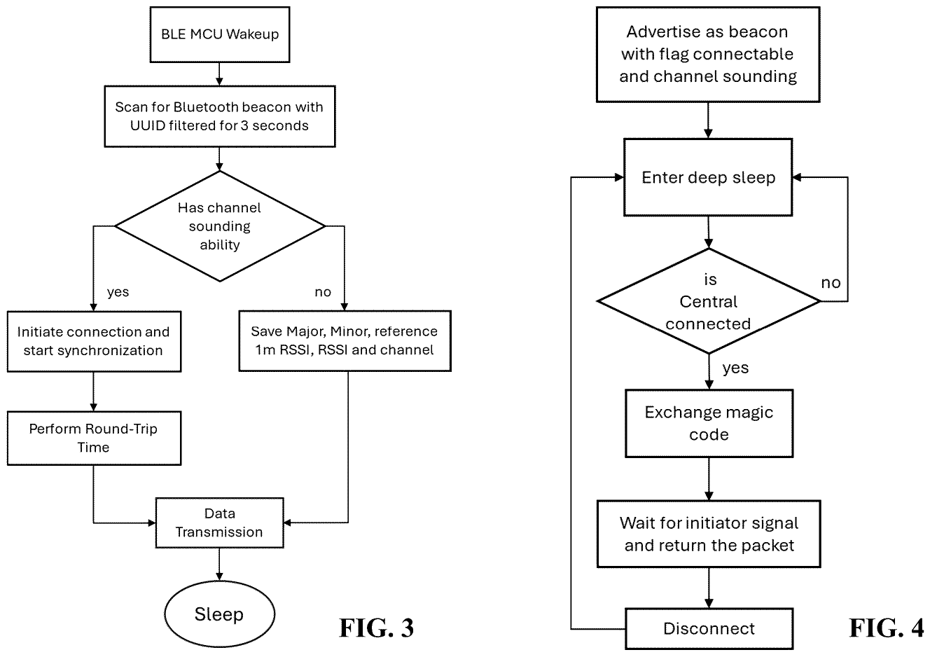

Furthermore, in the present invention, an enhanced positioning methodology is provided, called enhanced device-to-device positioning using two-way ranging. FIG. 3 and FIG. 4 illustrate an enhanced positioning methodology that improves location accuracy for tracking devices operating in beacon mode according to some embodiments of the present invention. FIG. 3 shows the internal workflow of a tracking device operating in standard mode, and FIG. 4 shows the operational process of a beacon-mode tracking device when it participates in active two-way ranging.

As illustrated in FIG. 3, a tracking device operating in standard mode may perform a BLE-based device-to-device ranging process by executing a sequence of operations beginning with a wake-up event triggered by its BLE microcontroller unit (MCU).

Upon wake-up, the detection module initiates a Bluetooth scan with UUID filtering for a fixed duration (e.g., three seconds), targeting advertising packets from nearby beacon-mode devices. If no beacon is detected during the scan window, the tracking device returns to sleep mode. When a beacon is detected, the tracking device evaluates whether the detected beacon-mode tracker has channel sounding capability (i.e., the ability to participate in RTT ranging). This determination may be made using metadata included in the beacon payload, such as device capability flags.

If the channel sounding capability is confirmed, the wireless communication module initiates a Bluetooth connection and synchronization sequence with the beacon-mode device. Upon successful synchronization, the positioning module performs a RTT measurement by transmitting a timestamped probe packet and receiving an acknowledgment. The RTT result is used to estimate the distance between the two devices with high accuracy. If the channel sounding capability is absent, the tracking device does not attempt to connect. Alternatively, the positioning module saves key broadcast data including the beacon's Major and Minor identifiers, the RSSI at the time of reception, a reference RSSI value corresponding to 1-meter range (RSSI₁ₘ), and the Bluetooth channel on which the signal is received. This data may later be used for RSSI-based triangulation or location estimation.

After either RTT measurement or passive RSSI data collection, the tracking device uses the wireless communication module to transmit the collected information, uploading the collected ranging information to a central server or cloud platform. Upon completion, the tracking device returns to sleep mode until the next wake cycle.

As illustrated in FIG. 4, a tracking device operating in beacon mode executes a cooperative procedure that enables participation in RTT-based distance measurements initiated by a standard-mode tracking device. This procedure begins with the wireless communication module entering a broadcasting state, where it advertises as a beacon. The advertisement includes flags indicating both connection ability and channel sounding capability, thereby signaling to nearby standard-mode tracking devices that RTT cooperation is supported.

Immediately after broadcasting, the beacon-mode tracking device transitions into deep sleep mode to conserve energy. During this state, the power management module is configured to maintain readiness to detect incoming connection requests.

The beacon-mode tracking device then determines whether a central device has successfully initiated a connection. If no connection is detected (i.e., no standard-mode device attempts to initiate RTT), the beacon-mode tracking device resumes its advertisement-sleep cycle without further processing. If a connection is successfully established (i.e., “Yes” branch), the wireless communication module initiates a code exchange protocol with the connected standard-mode tracking device. This step involves sending a predetermined synchronization token, referred to as a magic code, to ensure that both tracking devices are aligned in the ranging process.

Following successful synchronization, the beacon-mode tracking device enters a standby state to wait for the initiator signal, which is a timestamped probe packet sent from the central device (e.g., the standard-mode tracking device). Upon receiving the probe, the positioning module promptly returns a response packet using the same wireless channel, thereby completing the round-trip exchange needed for RTT calculation. After the response is transmitted, the wireless communication module performs a disconnect operation, terminating the connection and returning the tracking device to its low-power advertising cycle for future interactions.

The following describes different usage scenarios of the tracking system.

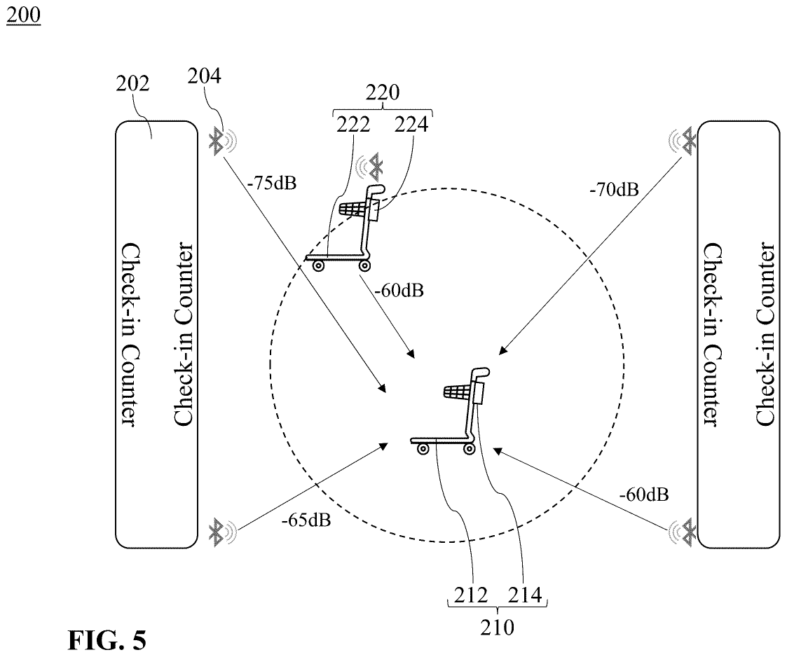

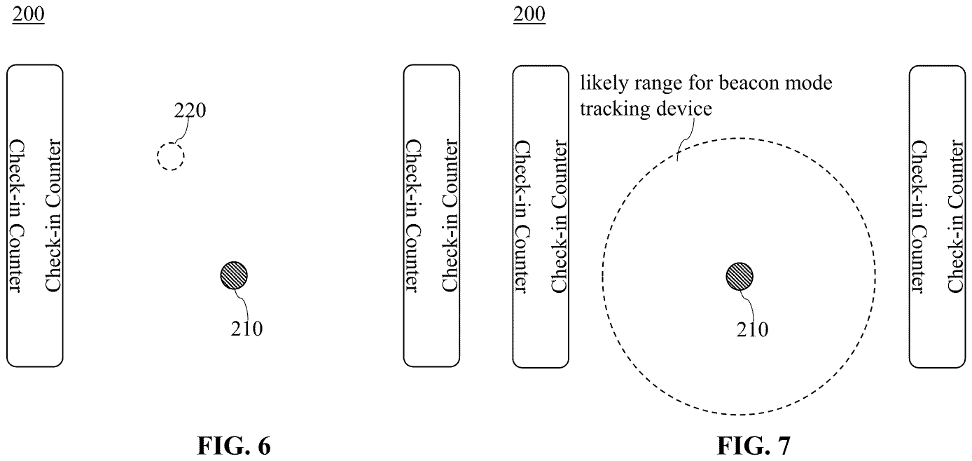

FIG. 5 illustrates an example usage scenario of a tracking system 200 for locating assets in an environment using indoor positioning according to some embodiments of the present invention. FIG. 6 illustrates an interactive map interface in which a tracking device disappears from view after entering beacon mode due to low battery according to some embodiments of the present invention. FIG. 7 illustrates the signal perception range of a tracking device operating in the standard mode and detecting beacon signals from a nearby offline device according to some embodiments of the present invention.

A tracking system 200 comprises multiple tracking devices 210, 220 as afore-described and check-in counters 202. The tracking device 210 includes a movable body 212 and a tracking configuration 214 attached to the movable body 212. The tracking device 220 includes a movable body 222 and a tracking configuration 224 attached to the movable body 222. In some embodiments, they are airport trolleys with the same hardware configuration.

Specifically, each of the tracking devices 210, 220 includes a battery module to power all internal components, a wireless communication module to enable data transmission over Wi-Fi, Bluetooth, LTE, and GNSS, a power management module configured to monitor voltage and network conditions, a positioning module for location determination using Bluetooth and GNSS signals, and a detection module for identifying nearby beacon-mode trackers.

The tracking system 200 further comprises at least one transceiver unit 204 positioned at a fixed location of the check-in counter 202. The transceiver unit 204 is configured to periodically transmit wireless identification signals over Bluetooth Low Energy (BLE), which are detectable by the tracking devices 210, 220 when they operate in the standard mode. In some embodiments, the wireless identification signals transmitted at fixed intervals (e.g., 250 milliseconds to 2 seconds) using BLE advertising channels (37: 2402 MHz, 38: 2426 MHz, and 39: 2480 MHz). In some embodiments, the transceiver unit 204 may be implemented as a standalone BLE beacon device, a BLE-enabled gateway, or an integrated module within an airport infrastructure system capable of broadcasting identification signals.

In FIG. 5, the tracking device 210 operates in the standard mode, meaning that both its battery level and network connectivity satisfy predefined operational thresholds. The tracking device 210 receives BLE signals from fixed-position transceiver units 204 deployed along the aisles, such as those installed at check-in counters 202. In normal operation for the tracking device 210, the tracking configuration 214 installed on the movable body 212 automatically provides accurate positioning data by using Bluetooth technology for indoor tracking and GPS technology for outdoor tracking. For indoor positioning, the position of tracking device 210 can be calculated by analyzing RSSI values obtained from multiple reference points, where the transceiver units 204 are located. The calculated location data is then transmitted to a cloud server of the tracking system 200 via a wireless communication channel, such as a cellular network.

The RSSI values shown in FIG. 5 (e.g., −60 dB, −65 dB, −70 dB, −75 dB) represent the signal strength received by the tracking device 210 from nearby BLE transceivers. A higher RSSI value (i.e., closer to zero) indicates stronger signal strength and therefore a shorter distance between the tracking device 210 and the corresponding signal source. These RSSI measurements are used to estimate distances and enable indoor positioning through triangulation. Based on these calculations, the position of the tracking device 210 is accurately determined and displayed on the interactive map, as illustrated in FIG. 6.

Also, as shown in FIG. 5, the tracking device 220 represents a case where the battery module thereof no longer provides sufficient voltage to sustain LTE communication. When the battery level drops below the operational threshold for cellular connectivity, the power management module of the tracking device 220 initiates power conservation protocols. The tracking device 220 enters a low-power sleep mode, and due to suspended data transmission, it becomes unavailable on the online portal map. In FIG. 6, the dotted circle in the illustration for the tracking device 220 indicates that the tracking device 220 would normally appear when the tracker is fully functional, but it has now disappeared from the interface.

As a result, the power management module of the tracking device 220 transitions the tracking device 220 into beacon mode. In this state, the positioning module of the tracking device 220 reconfigures the wireless communication module of tracking device 220 to function as a Bluetooth advertiser, broadcasting a unique identifier at fixed intervals (e.g., once per second). Although the tracking device 220 no longer transmits location data to the cloud, it continues to broadcast its identifier via BLE.

Meanwhile, the tracking device 210 remains in the standard mode and utilizes its detection module to receive the beacon signals emitted by the tracking device 220. The tracking device 210 measures the RSSI of the received signal and, optionally, applies RTT analysis via the positioning module thereof to estimate the distance to the tracking device 220. This estimated distance is then used to render a circular proximity indicator around the tracking device 210 on the interactive map, as shown in FIG. 7, indicating the likely range of the tracking device 220's last known location.

The tracking system may employ different estimation methods depending on how many tracking devices are available. Detailed descriptions are given below.

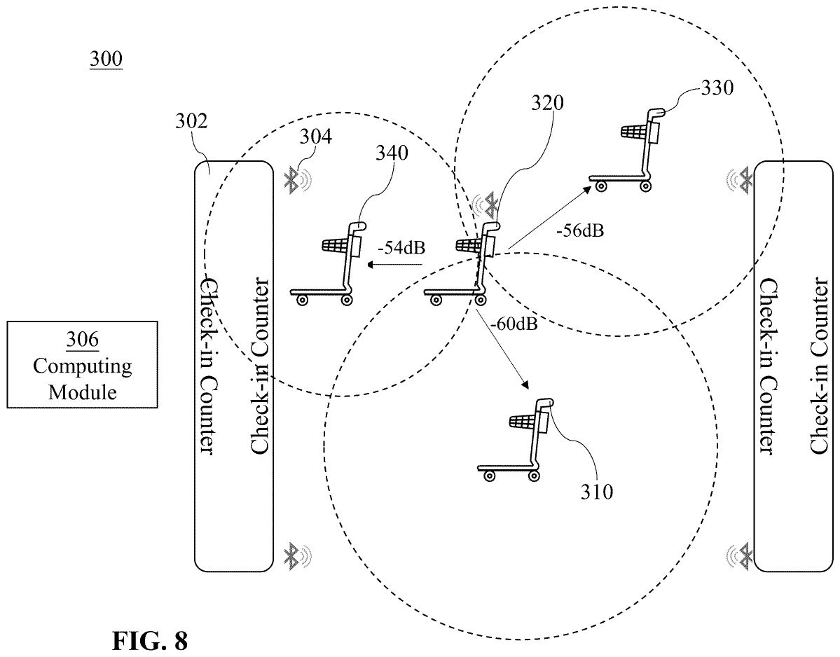

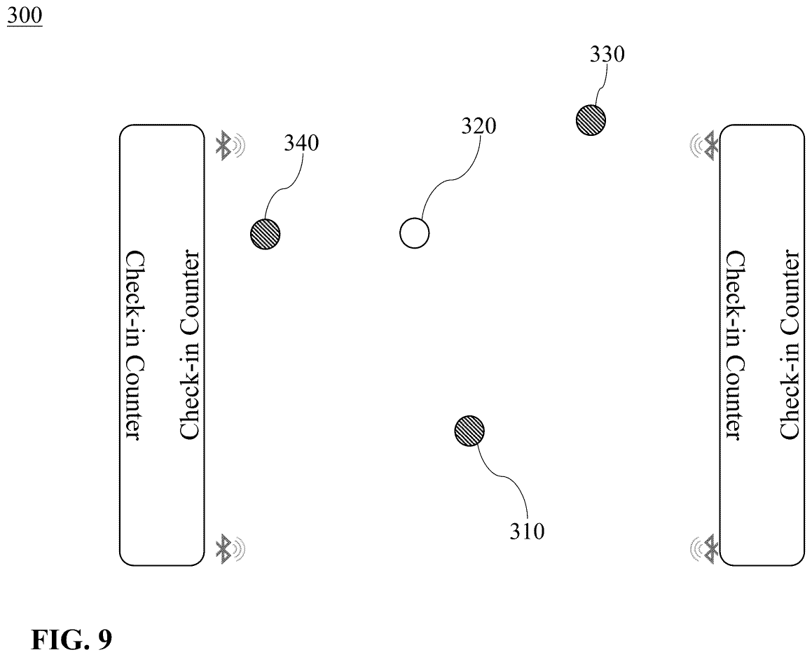

FIG. 8 illustrates an example usage scenario of a tracking system 300 for locating assets in an environment using indoor positioning according to some embodiments of the present invention. FIG. 9 illustrates an interactive map interface in which a tracking device disappears from view after failed to upload location information to cloud server due to low power or network ability issues, but the accurate location can be appeared again by entering beacon mode and by the help of nearby normal tracking devices (RSSI-based triangulation needs ≥3 devices) according to some embodiments of the present invention. Specifically, FIG. 7 illustrates that when the signal from a BLE mode tracker is received by only one standard-mode tracker, only an approximate range of the BLE tracker can be estimated. FIG. 9, on the other hand, demonstrates that when the BLE signal is received by three or more standard-mode trackers, the precise position of the BLE-mode tracker can be calculated using triangulation.

This scenario involves multi-device cooperative positioning and fallback estimation. The tracking system 300 includes a plurality of tracking devices 310, 320, 330, 340. Each of the tracking devices 310, 320, 330, 340 is configured with a movable body and a tracking configuration attached to the movable body, in which the tracking configuration includes a battery module, a wireless communication module, a power management module, a positioning module, and a detection module, as previously described. Accordingly, they have the same or identical hardware configuration. The tracking system 300 also includes a plurality of transceiver units 304 deployed at a fixed location of check-in counters 302, which periodically broadcasts Bluetooth identification signals detectable by tracking devices operating in the standard mode.

In some embodiments, each of the tracking device 310, 320, 330, 340 is capable of entering a beacon mode when the battery voltage is insufficient to sustain cellular or Wi-Fi communication. As shown in the comparison table, cellular modules require a minimum of 3.3V and consume at least 70 mA of current, whereas BLE beacon transmission only requires 1.8V and consumes less than 10 μA. Due to this ultra-low power requirement, even if the tracking device 310, 320, 330, 340 retains as little as 10 mAh of battery capacity, it may continue to operate in beacon mode for up to about 41 days. This allows asset recovery to remain possible over an extended period, even under severe power constraints.

Comparison table. Power Consumption:
Cellular Data vs. Bluetooth Beacons

| Technology | Minimum Supply Voltage | Power Consumption |
|---|---|---|
| Cellular | 3.3 V | ≥70 mA |
| BLE Beacon | 1.8 V | ≤10 μA |

As illustrated in FIG. 8, the tracking device 320 operates in beacon mode due to insufficient battery voltage for LTE or Wi-Fi communication, or alternatively, as a result of degraded network capability. The tracking devices 310, 330, and 340 operate in standard mode, forming a configuration that satisfies the requirement of using three or more standard-mode trackers for triangulation. In this scenario, the tracking device 320 in the beacon mode broadcasts a Bluetooth advertising signal at predefined intervals (e.g., once per second), using the wireless communication module thereof as a BLE advertiser, under the control of the positioning module thereof.

The tracking devices 310, 330, and 340, which are in standard mode, utilize their respective detection modules to receive the beacon signals from the tracking device 320. Each of the tracking devices 310, 330, and 340 independently measures RSSI values or optionally performs RTT measurements via its positioning module to estimate its respective distance to the tracking device 320 in the beacon mode. These individual distance estimations are then combined in a multilateration algorithm, executed either locally or remotely, to compute the estimated position of the tracking device 320 in the beacon mode with improved spatial accuracy. The result is displayed on an interactive map as shown in FIG. 9, even though the tracking device 320 in the beacon mode itself is not actively transmitting GPS or cloud data.

In some fallback scenarios, none of the standard-mode tracking devices (e.g., the tracking devices 310, 330, and 340) may successfully receive the beacon signals from the beacon-mode device (e.g., the tracking device 320) due to occlusion, signal degradation, or exceeding range limitations. In some embodiments, the tracking system 300 may further comprise a computing module 306 in a cloud server which is configured to perform exclusion-based location estimation. Each of the standard-mode tracking devices (e.g., the tracking devices 310, 330, and 340) has a known position and a defined reception range, either preset or calibrated. Based on the absence of detected signals from the beacon-mode device (e.g., the tracking device 320), the computing module 306 identifies the spatial region that lies outside the union of all reception ranges, and estimates that the beacon-mode device is likely located within that uncovered region. This mechanism allows the tracking system 300 to infer a probable area of asset presence even under severe signal loss.

As discussed above, in contrast to conventional commercial asset trackers, which either rely on low-accuracy GNSS positioning and Bluetooth positioning or require costly infrastructure for high-accuracy technologies like Ultra-Wideband (UWB), the present invention introduces a power-aware and infrastructure-independent solution that remains operational even under degraded conditions. The tracking device of the present invention continues to support positioning when the battery voltage drops below thresholds typically required for LTE or Wi-Fi modules, operating effectively within the 1.8V˜3V range. By dynamically switching between Bluetooth scanner and beacon roles based on device state, and between Bluetooth initiator and reflector roles for RTT ranging, the tracking device enables precise distance estimation through channel sounding techniques. Furthermore, multiple tracking devices may collaborate to locate an offline tracker using multilateration algorithms, all without requiring additional hardware such as buzzers or LEDs. The tracking system supports both indoor and outdoor environments and enables reliable asset localization even when a tracking device is in a low-power or offline state, thereby overcoming key limitations of existing technologies.

The functional units and modules of the systems and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A tracking device for recovering asset location in offline conditions, comprising:
a movable body equipped with a battery module;
a wireless communication module positioned at the movable body and configured to perform wireless communication with external devices or systems;
a power management module positioned at the movable body and configured to monitor a voltage level of the battery module and a network availability status of the wireless communication module, and to selectively activate one of a standard mode or a beacon mode based on the voltage level and the network availability;
a positioning module positioned at the movable body and configured to:
in the standard mode, perform at least one wireless-based positioning process to determine a location of the tracking device; and
in the beacon mode, transmit a wireless signal containing an identifier at predefined time intervals; and
a detection module positioned at the movable body and configured to detect wireless signals originating from additional tracking devices operating in the beacon mode when the tracking device is operating in the standard mode.

2. The tracking device of claim 1, wherein the wireless communication module is configured to support at least Wi-Fi, Bluetooth, cellular (LTE), and global navigation satellite system (GNSS) connectivity.

3. The tracking device of claim 2, wherein the wireless communication module is further configured to transmit location data through either Wi-Fi or cellular networks when the network availability is available.

4. The tracking device of claim 1, wherein the positioning module comprises a Bluetooth-based positioning engine and a GNSS-based positioning engine.

5. The tracking device of claim 4, wherein the positioning module is further configured to perform two-way ranging by measuring round-trip time of Bluetooth signals exchanged with another tracking device, to calculate a distance.

6. The tracking device of claim 4, wherein the detection module is further configured to estimate a position of another tracking device operating in the beacon mode by analyzing received signal strength indicator (RSSI) values and channel state information (CSI) acquired from received wireless signals.

7. The tracking device of claim 4, wherein the power management module is further configured to transition from a sleep mode to an active state at predefined time intervals and to initiate a battery voltage check and a network connectivity check, and wherein, when both the battery voltage and the network connectivity satisfy predefined operational thresholds,
the power management module is further configured to activate the standard mode;
the detection module is further configured to perform scanning for beacon signals;
the positioning module is further configured to acquire GNSS data; and
the wireless communication module is further configured to transmit location information;
and wherein, when either the battery voltage or the network connectivity falls below the corresponding predefined operational threshold, the power management module is further configured to activate the beacon mode, and the positioning module is configured to transmit beacon signals at predefined intervals.

8. The tracking device of claim 1, wherein the power management module is configured to activate the beacon mode when the voltage level of the battery module falls below a first threshold required for cellular communication, or a second threshold required for Wi-Fi communication, and remains above a third threshold sufficient for Bluetooth transmission.

9. A tracking system for locating an offline tracking device in an environment, comprising:
more than one tracking device according to claim 1; and
at least one transceiver unit positioned at a fixed counter and configured to periodically transmit wireless identification signals detectable by the tracking devices when operating in the standard mode, wherein each of the tracking devices is configured to receive the wireless identification signals from the transceiver unit and to use signal strength or timing characteristics of the received wireless identification signals to assist in determining the respective location of the tracking devices.

10. The tracking system of claim 9, wherein a first tracking device of the tracking devices is operating in the beacon mode and is configured to periodically transmit wireless signals containing an identifier, and a second tracking device of the tracking devices is operating in the standard mode and is configured to receive the wireless signals from the first tracking device in the beacon mode.

11. The tracking system of claim 10, wherein the second tracking device in the standard mode is further configured to estimate a distance to the first tracking device in the beacon mode based on received signal strength indicator (RSSI) or round-trip time (RTT) of the received signals.

12. The tracking system of claim 11, wherein the second tracking device in the standard mode is further configured to determine an approximate location of the first tracking device in the beacon mode based on the estimated distance and to transmit the estimated location to the transceiver unit.

13. The tracking system of claim 9, wherein a first tracking device of the tracking devices is operating in the beacon mode and is configured to transmit wireless signals containing an identifier, and at least three second tracking devices of the tracking devices are operating in the standard mode and are configured to receive the wireless signals from the first tracking device in the beacon mode.

14. The tracking system of claim 13, wherein each of the second tracking devices in the standard mode is configured to estimate a respective distance to the first tracking device in the beacon mode based on characteristics of the received wireless signals.

15. The tracking system of claim 14, wherein the estimated distances from the at least three second tracking devices in the standard mode are used in a multilateration algorithm to calculate a position of the first tracking device in the beacon mode.

16. The tracking system of claim 15, further comprising:
a computing module configured to estimate a probable location of the first tracking device in the beacon mode based on signal absence conditions,
wherein each of the second tracking devices has a known physical location and a defined reception range, and
wherein the computing module is configured to estimate a probable region in which the first tracking device is located, the probable region being outside the combined reception ranges of all of the second tracking devices, based on the fact that none of the second tracking devices receives wireless signals from the first tracking device.

17. A method for estimating a location of a tracking device operating in a beacon mode within an environment, comprising:
receiving, by one or more standard-mode tracking devices, wireless signals transmitted from a beacon-mode tracking device;
estimating, by the one or more standard-mode tracking devices, distance information regarding the beacon-mode tracking device based on characteristics of the received signals; and
computing a location of the beacon-mode tracking device based on the estimated distance information.

18. The method of claim 17 wherein the one standard-mode tracking device receives the wireless signals from the beacon-mode tracking device, and the location of the beacon-mode tracking device is approximated based on a single distance estimation and the known position of the standard-mode tracking device.

19. The method of claim 17, wherein the wireless signals are received by at least three of the standard-mode tracking devices, and the location of the beacon-mode tracking device is computed using a multilateration algorithm based on distance estimations and known positions of the standard-mode tracking devices.

20. The method of claim 17, further comprising:
identifying that none of the standard-mode tracking devices receives any wireless signal from the beacon-mode tracking device;
retrieving known positions and defined reception ranges of the standard-mode tracking devices; and
estimating a probable region in which the beacon-mode tracking device is located, the region lying outside a combined reception range of all the standard-mode tracking devices.
